(19) United States
(12) Patent Application Publication
(10) Pub. No.: US 2023/0042522 A1
(43) Pub. Date: Feb. 9, 2023

(54) INKJET COMPOSITION

(71) Applicant: HEWLETT-PACKARD DEVELOPMENT COMPANY, L.P., Spring, TX (US)

(72) Inventors: Jayprakash C. Bhatt, Corvallis, OR (US); Marcos A. Barreto Caban, Aguadilla, PR (US); Sundar Vasudevan, Corvallis, OR (US)

(21) Appl. No.: 17/384,117

(22) Filed: Jul. 23, 2021

(51) Int. Cl. C09D 11/38; C09D 11/322; C09D 11/36; B41M 5/00

(52) U.S. Cl. CPC C09D 11/38; C09D 11/322; C09D 11/36; B41M 5/0023

(57) ABSTRACT

An example of an inkjet composition includes a colorant, a density modifier selected from the group consisting of a triiodo amino derivative of isophthalic acid, a mixture of polysucrose and sodium diatrizoate, colloidal silica particles coated with polyvinylpyrrolidone, and combinations thereof; and an aqueous vehicle. The inkjet composition may be inkjet printed on a substrate, using a thermal or piezoelectric printer.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. The technology has become a popular way of recording images on various media surfaces (e.g., paper), for a number of reasons, including, low printer noise, capability of high-speed recording and multi-color recording.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features of examples of the present disclosure will become apparent by reference to the following detailed description and drawings.

FIG. 1 is a schematic illustration of an example inkjet composition;

FIG. 2 is a text diagram illustrating an example of a printing method;

FIG. 3 depicts an example of a printing system and ink cartridge configuration;

FIG. 4 is a flow diagram illustrating an example of making an example of the inkjet composition;

FIG. 5A is a graph depicting the sedimentation rate of a comparative inkjet composition without a density modifier, plotting the position of the sample in millimeters (mm, X axis) measured from the front/top of the vial vs. light transmittance through the sample, as a percentage (%, Y axis);

FIG. 5B is a graph depicting the sedimentation rate of an example inkjet composition with 2 wt % active of a density modifier, plotting the position of the sample in millimeters (mm, X axis) measured from the front/top of the vial vs. light transmittance through the sample, as a percentage (%, Y axis);

FIG. 5C is a graph depicting the sedimentation rate of an example inkjet composition with 6% active of a density modifier, plotting the position of the sample in millimeters (mm, X axis) measured from the front/top of the vial vs. light transmittance through the sample, as a percentage (%, Y axis);

FIG. 5D is a graph depicting the sedimentation rate of an example inkjet composition with 9% active of a density modifier, plotting the position of the sample in millimeters (mm, X axis) measured from the front/top of the vial vs. light transmittance through the sample, as a percentage (%, Y axis);

FIG. 6 is a graph depicting the settling rate (μm/s, Y axis) versus the weight percentage of a density modifier (wt %, X axis) in the comparative inkjet composition and the three example inkjet compositions;

FIG. 7A is a graph depicting the sedimentation rate of an additional comparative inkjet composition without a density modifier, plotting the position of the sample in millimeters (mm, X axis) measured from the front/top of the vial vs. light transmittance through the sample, as a percentage (%, Y axis);

FIG. 7B is a graph depicting the sedimentation rate of an additional example inkjet composition with 2 wt % active of a density modifier, plotting the position of the sample in millimeters (mm, X axis) measured from the front/top of the vial vs. light transmittance through the sample, as a percentage (%, Y axis);

FIG. 7C is a graph depicting the sedimentation rate of an example inkjet composition with 4% active of a density modifier, plotting the position of the sample in millimeters (mm, X axis) measured from the front/top of the vial vs. light transmittance through the sample, as a percentage (%, Y axis);

FIG. 7D is a graph depicting the sedimentation rate of an additional example inkjet composition with 6% active of a density modifier, plotting the position of the sample in millimeters (mm, X axis) measured from the front/top of the vial vs. light transmittance through the sample, as a percentage (%, Y axis);

FIG. 7E is a graph depicting the sedimentation rate of an additional example inkjet composition with 9% active of a density modifier, plotting the position of the sample in millimeters (mm, X axis) measured from the front/top of the vial vs. light transmittance through the sample, as a percentage (%, Y axis);

FIG. 7F is a graph depicting the sedimentation rate of an example inkjet composition with 10% active of a density modifier, plotting the position of the sample in millimeters (mm, X axis) measured from the front/top of the vial vs. light transmittance through the sample, as a percentage (%, Y axis); and

FIG. 8 is a graph depicting the settling rate (μm/s, Y axis) versus the weight percentage of a density modifier (wt %, X axis) in the additional comparative ink composition and the five additional example ink compositions.

### DETAILED DESCRIPTION

In inkjet printing, the inkjet composition can affect both the printability of the ink and the longevity of the printhead and nozzles of the printer. As such, ink performance, in terms of both printability and long-term nozzle health, may be controlled by modifying the components of the inkjet composition. It is also desirable for the inkjet composition to be stable so that the inkjet composition can be jetted reliably, even after storage. By “stable,” it is meant that the solid components remain dispersed in the ink vehicle. Unstable inks may impact nozzle health, print reliability and print consistency.

In pigment based inks, nanometer sized (in terms of diameter) pigment particles are dispersed in, and thus suspended in, a medium. However, these solid ink components are prone to settling, and thus contribute to ink instability. Settling of the pigment particles out of the medium may lead to unstable inks, as described above, which shortens the shelf life of the ink.

One way to measure the stability of an inkjet composition is to measure the sedimentation rate. The sedimentation rate of particles in a medium can be described by the Stokes equation, which describes the movement of a sphere in a gravitational field. The Stokes equation (eq. 1 below) calculates the velocity of sedimentation (v) using five parameters, wherein d=the diameter of the sphere, p=the particle density, L=the medium density, n=the viscosity of the medium, and g=gravitational force.

$$v = \frac{{d}^{2} ( p - L ) \times ℊ}{18 n} \qquad ( eq . 1 )$$

In the examples disclosed herein, the pigment settling (i.e., the sedimentation rate) is reduced by reducing the difference between the pigment particle density and the medium (i.e., the aqueous vehicle) density, (p-L). Pigment particles of higher density, or larger size, typically travel at a faster rate and at some point will be separated from pigment particles that are less dense, or of a smaller size. By reducing the difference in density between the pigment particles and the medium, the sedimentation rate will decrease, according to the Stokes equation. However, the viscosity of the medium is inversely related to the rate of sedimentation, and thus, it is desirable to increase the density of the medium without adversely affecting the viscosity of the medium. For example, an increase in viscosity can affect the printability from a thermal or piezoelectric inkjet printer, and could render the inkjet composition unjettable (e.g., nozzle clogging, etc.).

The inkjet compositions disclosed herein include a density modifier. The density modifier increases the density of the inkjet composition, while maintaining the viscosity of the inkjet composition within inkjettable ranges. In examples of the inkjet composition that include pigment, the effect of the density modifier leads to an overall reduction of pigment settling. These pigmented inkjet compositions exhibit long-term stability, and maintain jettability. In examples of the inkjet composition including the dye, the density modifier increases the drop weight without also increasing the drop volume. This increases the momentum of the dispensed drops, which may lead to improved decap performance. Improved decap performance may also improve the image quality of the printed images.

Throughout this disclosure, a weight percentage that is referred to as “wt % active” refers to the loading of an active component of a dispersion or other formulation that is present in the inkjet composition. For example, a pigment may be present in a water-based formulation (e.g., a stock solution or dispersion) before being incorporated into the inkjet composition. In this example, the wt % actives of the pigment accounts for the loading (as a weight percent) of the pigment that is present in the inkjet composition, and does not account for the weight of the other components (e.g., water, etc.) that are present in the formulation with the pigment.

The viscosity measurements set forth herein represent those measured by a viscometer at a particular temperature and at a particular shear rate (s⁻¹) or at a particular speed. The temperature and shear rate or temperature and speed are identified with individual values. Viscosity may be measured, for example, by a LVDV-II+ viscometer (from Brookfield) or another suitable instrument.

Inkjet Compositions

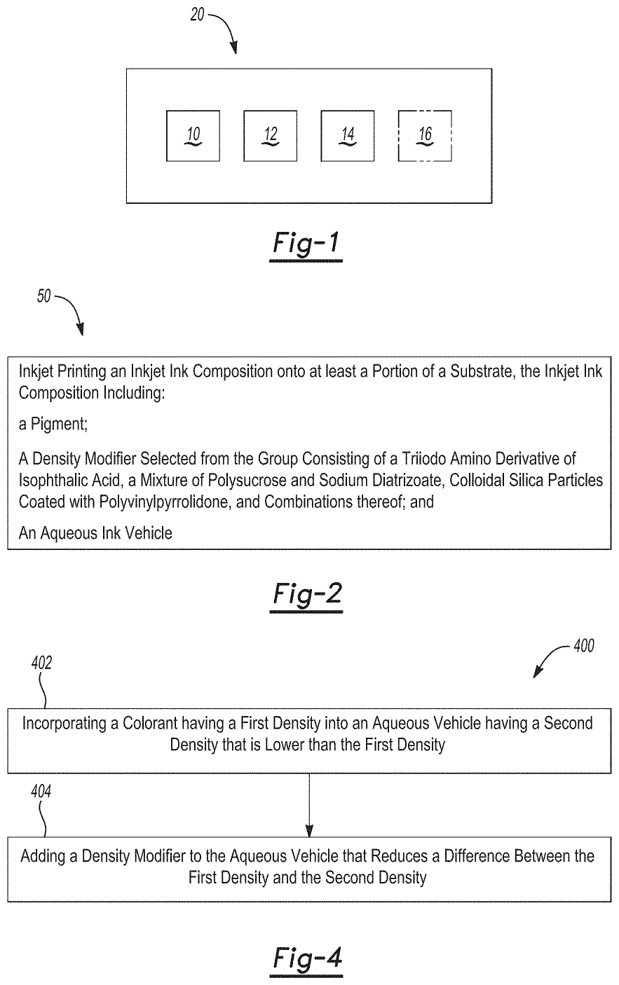

Examples of the inkjet composition disclosed herein are shown schematically in FIG. 1. As depicted, one example of the inkjet composition 20 includes a colorant 10, a density modifier 12 selected from the group consisting of a triiodo amino derivative of isophthalic acid, a mixture of polysucrose and sodium diatrizoate, colloidal silica particles coated with polyvinylpyrrolidone, and combinations thereof, and an aqueous vehicle 14.

In an example, the inkjet composition 20 includes these components (e.g., a colorant 10, a density modifier 12, and an aqueous vehicle 14) without other additives. In another example, the inkjet composition 20 includes these components (e.g., a colorant 10, a density modifier 12, and an aqueous vehicle 14), as well as at least one carbohydrate-containing solvent 16. In still other examples, the inkjet composition 20 includes these components (e.g., a colorant 10, a density modifier 12, and an aqueous vehicle 14), as well as other additives suitable for inkjet compositions not shown in FIG. 1, such as surfactant(s), anti-kogation agent(s), an anti-decel agent(s), an antimicrobial agent(s), or combinations thereof. In still another example, the inkjet composition 20 consists of a colorant 10, a density modifier 12, and an aqueous vehicle 14 that includes a co-solvent and a balance of water, as well as any one or more of the previously listed additives. In another example, the inkjet composition 20 consists of a colorant 10, a density modifier 12, an aqueous vehicle 14 that includes a co-solvent and a balance of water, a carbohydrate-containing solvent 16, as well as any one or more of the previously listed additives.

The inkjet composition 20 may be an inkjet ink composition, which is used to generate text, images, etc. on a suitable substrate. Examples of the inkjet ink composition include a pigment or dye as the colorant 10, the density modifier 12, and the aqueous vehicle 14. The inkjet composition 20 may alternatively be a shipping fluid composition, which is used in an inkjet pen of a printer during shipping and/or storage prior to initial use. Examples of the shipping fluid composition include dye as the colorant 10, the density modifier 12, the aqueous vehicle 14, and the carbohydrate-containing solvent 16. When the inkjet composition 20 is referenced, the fluid may be either the inkjet ink composition or the shipping fluid composition.

The inkjet composition 20 may be the inkjet ink composition. When the inkjet composition 20 is an inkjet ink composition, the colorant 10 may be a pigment or a dye. In some examples, the colorant 10 is present in an amount ranging from about 0.5 wt % active to about 12 wt % active, based on the total weight of the inkjet ink composition. In another example, the amount of the colorant 10 in the inkjet ink composition ranges from about 2.5 wt % active to about 5 wt % active based on the total weight of the inkjet ink composition. In still another example, the amount of colorant 10 in the inkjet ink composition ranges from about 3.5 wt % active to about 10 wt % active based on the total weight of the inkjet ink composition. These percentages represent the active colorant in the inkjet ink composition, and do not account for other components of a colorant dispersion (e.g., dispersant, water, co-solvent) that may be added to the inkjet ink composition with the colorant 10.

The inkjet composition 20 may be the shipping fluid composition. In some examples when the inkjet composition 20 is the shipping fluid composition, there may be no colorant 10. In other examples when the inkjet composition 20 is the shipping fluid composition, the colorant 10 may be a dye. In these examples, the amount of dye is based on its ultraviolet light-visible light (UV-Vis) absorbance. In an example, the dye is included in an amount such that its absorbance (measured at a wavelength of 676 nm) ranges from 0.5 to 2.0 at 1:10 dilution with the shipping fluid aqueous vehicle.

In some examples, the colorant 10 of the inkjet ink composition is a pigment. As used herein, “pigment” may generally include organic and/or inorganic pigment colorants that introduce color to the inkjet ink composition. The pigment can be dispersed with a separate dispersant or can be self-dispersed with a polymer, oligomer, or small molecule.

Examples of the inkjet ink composition may include a pigment that is not self-dispersing and a separate dispersant. Examples of these pigments, as well as suitable dispersants for these pigments will now be described.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50. Any quinacridone pigment or a co-crystal of quinacridone pigments may be used for magenta inks.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 155, C.I. Pigment Yellow 167, C.I. Pigment Yellow 172, C.I. Pigment Yellow 180, C.I. Pigment Yellow 185, and C.I. Pigment Yellow 213.

Carbon black may be a suitable inorganic black pigment. Examples of carbon black pigments include those manufactured by Mitsubishi Chemical Corporation (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company (such as, e.g., RAVEN® 5750, RAVEN® 5250, RAVEN® 5000, RAVEN® 3500, RAVEN® 1255, and RAVEN® 700); various carbon black pigments of the REGAL® series, BLACK PEARLS® series, the MOGUL® series, or the MONARCH® series manufactured by Cabot Corporation (such as, e.g., REGAL® 400R, REGAL® 330R, REGAL® 660R, BLACK PEARLS® 700, BLACK PEARLS® 800, BLACK PEARLS® 880, BLACK PEARLS® 1100, BLACK PEARLS® 4350, BLACK PEARLS® 4750, MOGUL® E, MOGUL® L, and ELFTEX® 410); and various black pigments manufactured by Orion Engineered Carbons (such as, e.g., Color Black FW1, Color Black FW2, Color Black FW2V, Color Black FW18, Color Black FW200, Color Black S150, Color Black S160, Color Black S170, PRINTEX® 35, PRINTEX® 75, PRINTEX® 80, PRINTEX® 85, PRINTEX® 90, PRINTEX® U, PRINTEX® V, PRINTEX® 140U, Special Black 5, Special Black 4A, and Special Black 4). An example of an organic black pigment includes aniline black, such as C.I. Pigment Black 1.

Examples of suitable white pigments include white metal oxide pigments, such as titanium dioxide (TiO₂), zinc oxide (ZnO), zirconium dioxide (ZrO₂), or the like. In one example, the white pigment is titanium dioxide. In an example, the titanium dioxide is in its rutile form.

In some examples, the white pigment may include white metal oxide pigment particles coated with silicon dioxide (SiO₂). In one example, the white metal oxide pigment content to silicon dioxide content can be from 100:3.5 to 5:1 by weight. In other examples, the white pigment may include white metal oxide pigment particles coated with silicon dioxide (SiO₂) and aluminum oxide (Al₂O₃). In one example, the white metal oxide pigment content to total silicon dioxide and aluminum oxide content can be from 50:3 to 4:1 by weight. One example of the white pigment includes TI-PURE® R960 (TiO₂ pigment powder with 5.5 wt % silica and 3.3 wt % alumina (based on pigment content)) available from Chemours. Another example of the white pigment includes TI-PURE® R931 (TiO₂ pigment powder with 10.2 wt % silica and 6.4 wt % alumina (based on pigment content)) available from Chemours. Still another example of the white pigment includes TI-PURE® R706 (TiO₂ pigment powder with 3.0 wt % silica and 2.5 wt % alumina (based on pigment content)) available from Chemours.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 64, C.I. Pigment Orange 66, C.I. Pigment Orange 71, and C.I. Pigment Orange 73.

Examples of commercially available non-self-dispersed pigments that may be used include PALIOGEN® Orange, HELIOGEN® Blue L 6901F, HELIOGEN® Blue NBD 7010, HELIOGEN® Blue K 7090, HELIOGEN® Blue L 7101F, HELIOGEN® Blue L 6470, HELIOGEN® Green K 8683, and HELIOGEN® Green L 9140 (available from BASF Corp.). Examples of black commercially available non-self-dispersed pigments include MONARCH® 1400, MONARCH® 1300, MONARCH® 1100, MONARCH® 1000, MONARCH® 900, MONARCH® 880, MONARCH® 800, and MONARCH® 700 (available from Cabot Corp.). Other examples of commercially available non-self-dispersed pigments include CHROMOPHTAL® Yellow 3G, CHROMOPHTAL® Yellow GR, CHROMOPHTAL® Yellow 8G, IGRAZIN® Yellow 5GT, IGRALITE® Rubine 4BL, MONASTRAL® Magenta, MONASTRAL® Scarlet, MONASTRAL® Violet R, MONASTRAL® Red B, and MONASTRAL® Violet Maroon B (available from CIBA). Still other examples of commercially available non-self-dispersed pigments include PRINTEX® U, PRINTEX® V, PRINTEX® 140U, PRINTEX® 140V, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4 (available from Evonik Ind.). Yet other examples of commercially available non-self-dispersed pigments include TIPURE® R-101 (available from DuPont), DALAMAR® Yellow YT-858-D and Heucophthal Blue G XBT-583D (available from Heubach). Yet other examples of commercially available non-self-dispersed pigments include Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM® Yellow HR, NOVOPERM® Yellow FGL, Hansa Brilliant Yellow 10GX, Permanent Yellow G3R-01, HOSTAPERM® Yellow H4G, HOSTAPERM® Yellow H3G, HOSTAPERM® Orange GR, HOSTAPERM® Scarlet GO, and Permanent Rubine F6B (available from Clariant). Yet other examples of commercially available non-self-dispersed pigments include QUINDO® Magenta, INDOFAST® Brilliant Scarlet, QUINDO® Red R6700, QUINDO® Red R6713, and INDOFAST® Violet (available from Mobay). Yet other examples of commercially available non-self-dispersed pigments include L74-1357 Yellow, L75-1331 Yellow, and L75-2577 Yellow, LHD9303 Black (available from Sun Chemical).

The average particle size of the pigments may range anywhere from about 20 nm to about 200 nm. In an example, the average particle size ranges from about 80 nm to about 150 nm. As used herein, the “average particle size” refers to a volume-weighted mean diameter of a particle size distribution.

Any of the pigments mentioned herein can be dispersed by a separate dispersant, such as a styrene (meth)acrylate dispersant, or another dispersant suitable for helping to keep the pigment suspended in the aqueous ink vehicle. For example, the dispersant can be any dispersing (meth)acrylate polymer, or other type of polymer, such as a maleic polymer or a dispersant with aromatic groups and a poly(ethylene oxide) chain.

In one example, the (meth)acrylate polymer dispersant can be a styrene-acrylic type dispersant polymer, as it can promote π-stacking between the aromatic ring of the dispersant and various types of pigments, such as copper phthalocyanine pigments, for example. In one example, the styrene-acrylic dispersant can have a weight average molecular weight (M_{w}) ranging from about 4,000 to about 30,000. In another example, the styrene-acrylic dispersant can have a weight average molecular weight ranging from about 8,000 to about 28,000, from about 12,000 to about 25,000, from about 15,000 to about 25,000, from about 15,000 to about 20,000, or about 17,000. Regarding the acid number, the styrene-acrylic dispersant can have an acid number from 100 to 350, from 120 to 350, from 150 to 250, from 155 to 185, or about 172, for example. Example commercially available styrene-acrylic dispersants can include JONCRYL® 671, JONCRYL® 71, JONCRYL® 96, JONCRYL® 680, JONCRYL® 683, JONCRYL® 678, JONCRYL® 690, JONCRYL® 296, JONCRYL® 696 or JONCRYL® ECO 675 (all available from BASF Corp.).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). Also, in some examples, the terms “(meth)acrylate” and “(meth)acrylic acid” can be used interchangeably, as acrylates and methacrylates are salts and esters of acrylic acid and methacrylic acid, respectively. Furthermore, mention of one compound over another can be a function of pH. For example, even if the monomer used to form the polymer was in the form of a (meth)acrylic acid during preparation, pH modifications during preparation or subsequently when added to the inkjet ink composition can impact the nature of the moiety (acid form vs. salt or ester form). Thus, a monomer or a moiety of a polymer described as (meth)acrylic acid or as (meth)acrylate should not be read so rigidly as to not consider relative pH levels, ester chemistry, and other general organic chemistry concepts.

The following are some example pigment and separate dispersant combinations: a carbon black pigment with a styrene acrylic dispersant; PB 15:3 (cyan pigment) with a styrene acrylic dispersant; PR122 (magenta) or a co-crystal of PR122 and PV19 (magenta) with a styrene acrylic dispersant; or PY74 (yellow) or PY155 (yellow) with a styrene acrylic dispersant.

Other dispersants may be used, such as non-ionic surfactants, anionic surfactants, or combinations thereof. Some examples of the dispersant include a self-emulsifiable, non-ionic wetting agent based on acetylenic diol chemistry (e.g., SURFYNOL® SEF from Evonik Resources Efficiency GmbH), an ethoxylated low-foam wetting agent (e.g., SURFYNOL® 440 and SURFYNOL® 465 from Evonik Resources Efficiency GmbH), a non-ionic acetylenic diol surface active agent (e.g., SURFYNOL® 104 from Evonik Resources Efficiency GmbH), a non-ionic, alkylphenylethoxylate and solvent free surfactant blend (e.g., SURFYNOL® CT-211 from Evonik Resources Efficiency GmbH), a non-ionic organic surfactant (e.g., TEGO® Wet 510 from Evonik Industries AG), non-ionic a secondary alcohol ethoxylate (e.g., TERGITOL® 15-S-5, TERGITOL® 15-S-7, TERGITOL® 15-S-9, and TERGITOL® 15-S-30 all from Dow Chemical Company), a water-soluble non-ionic surfactant (e.g., TERGITOL® TMN-6), and combinations thereof. Examples of anionic dispersants include those in the DOWFAX™ family (from Dow Chemical Company). Combinations of any of the previously listed dispersants may also be used.

When the separate dispersant is used, the separate dispersant may be present in an amount ranging from about 0.05 wt % active to about 6 wt % active of the total weight of the thermal inkjet ink. In some examples, the ratio of pigment to separate dispersant may range from 0.1 (1:10) to 10 (10:1).

In some instances, a cationic surfactant may be added with anionically dispersed pigments to reverse the polarity and give the pigment particles a net positive charge. An example of the cationic surfactant is tetradecyltrimethylammonium bromide (TTAB). The cationic surfactant may be added in excess of the anionic dispersant to achieve the desired effect. The use of the cationic surfactant to obtain a positively charged pigment dispersion is described in U.S. Pat. No. 7,926,928, which is incorporated herein by reference in its entirety.

In other examples, the inkjet ink composition includes a self-dispersed pigment, which includes a pigment and an organic group attached thereto.

Any of the pigments set forth herein may be used, such as carbon, phthalocyanine, quinacridone, azo, or any other type of organic pigment, as long as at least one organic group that is capable of dispersing the pigment is attached to the pigment. In some instances, multiple organic groups (of the same type or of different types) are attached to the pigment.

In some instances, the organic group that is attached to the pigment includes at least one aromatic group, an alkyl (e.g., C₁ to C₂₀), and an ionic or ionizable group. In other instances, the organic group that is attached to the pigment includes at least one aromatic group and an ionic or ionizable group.

The aromatic group may be an unsaturated cyclic hydrocarbon containing one or more rings and may be substituted or unsubstituted, for example with alkyl groups. Aromatic groups include aryl groups (for example, phenyl, naphthyl, anthracenyl, and the like) and heteroaryl groups (for example, imidazolyl, pyrazolyl, pyridinyl, thienyl, thiazolyl, furyl, triazinyl, indolyl, and the like).

When included, the alkyl may be branched or unbranched, substituted or unsubstituted.

In some examples, the ionic or ionizable group may be at least one phosphorus-containing group, at least one sulfur-containing group, or at least one carboxylic acid group. In other examples, the ionic or ionizable group may be a cationically charged ionic group or a cationically chargeable ionizable group.

In an example, the at least one phosphorus-containing group has at least one P—O bond or P═O bond, such as at least one phosphonic acid group, at least one phosphinic acid group, at least one phosphinous acid group, at least one phosphite group, at least one phosphate, diphosphate, triphosphate, or pyrophosphate groups, partial esters thereof, or salts thereof. By “partial ester thereof”, it is meant that the phosphorus-containing group may be a partial phosphonic acid ester group having the formula —PO₃RH, or a salt thereof, wherein R is an aryl, alkaryl, aralkyl, or alkyl group. By “salts thereof”, it is meant that the phosphorus-containing group may be in a partially or fully ionized form having a cationic counterion.

When the organic group includes at least two phosphonic acid groups or salts thereof, either or both of the phosphonic acid groups may be a partial phosphonic ester group. Also, one of the phosphonic acid groups may be a phosphonic acid ester having the formula —PO₃R₂, while the other phosphonic acid group may be a partial phosphonic ester group, a phosphonic acid group, or a salt thereof. In some instances, it may be desirable that at least one of the phosphonic acid groups is either a phosphonic acid, a partial ester thereof, or salts thereof. When the organic group includes at least two phosphonic acid groups, either or both of the phosphonic acid groups may be in either a partially or fully ionized form. In these examples, either or both may of the phosphonic acid groups have the formula —PO₃H₂, —PO₃H⁻ M⁺ (monobasic salt), or —PO₃⁻² M⁺² (dibasic salt), wherein M⁺is a cation such as Na⁺, K⁺, Li⁺, or NR₄⁺, wherein R, which can be the same or different, represents hydrogen or an organic group such as a substituted or unsubstituted aryl and/or alkyl group.

As other examples, the organic group may include at least one geminal bisphosphonic acid group, partial esters thereof, or salts thereof. By “geminal”, it is meant that the at least two phosphonic acid groups, partial esters thereof, or salts thereof are directly bonded to the same carbon atom. Such a group may also be referred to as a 1,1-diphosphonic acid group, partial ester thereof, or salt thereof.

An example of a geminal bisphosphonic acid group may have the formula —CQ(PO₃H₂)₂, or may be partial esters thereof or salts thereof. Q is bonded to the geminal position and may be H, R, OR, SR, or NR₂ wherein R, which can be the same or different when multiple are present, is selected from H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. For examples, Q may be H, R, OR, SR, or NR₂, wherein R, which can be the same or different when multiple are present, is selected from H, a C₁-C₆ alkyl group, or an aryl group. As specific examples, Q is H, OH, or NH₂. Another example of a geminal bisphosphonic acid group may have the formula —(CH₂)ₙCQ(PO₃H₂)₂, or may be partial esters thereof or salts thereof, wherein Q is as described above and n is 0 to 9, such as 1 to 9. In some specific examples, n is 0 to 3, such as 1 to 3, or n is either 0 or 1.

Still another example of a geminal bisphosphonic acid group may have the formula —X—(CH₂)ₙCQ(PO₃H₂)₂, or may be partial esters thereof or salts thereof, wherein Q and n are as described above and X is an arylene, heteroarylene, alkylene, vinylidene, alkarylene, aralkylene, cyclic, or heterocyclic group. In specific examples, X is an arylene group, such as a phenylene, naphthalene, or biphenylene group, which may be further substituted with any group, such as one or more alkyl groups or aryl groups. When X is an alkylene group, examples include substituted or unsubstituted alkylene groups, which may be branched or unbranched and can be substituted with one or more groups, such as aromatic groups. Examples of X include C₁-C₁₂ groups like methylene, ethylene, propylene, or butylene. X may be directly attached to the pigment, meaning there are no additional atoms or groups from the attached organic group between the pigment and X. X may also be further substituted with one or more functional groups. Examples of functional groups include R′, OR′, COR′, COOR′, OCOR′, carboxylates, halogens, CN, NR′₂, SO₃H, sulfonates, sulfates, NR′(COR′), CONR′₂, imides, NO₂, phosphates, phosphonates, N═NR′, SOR′, NR′SO₂R′, and SO₂NR′₂, wherein which can be the same or different when multiple are present, is independently selected from hydrogen, branched or unbranched C₁-C₂₀ substituted or unsubstituted, saturated or unsaturated hydrocarbons, e.g., alkyl, alkenyl, alkynyl, substituted or unsubstituted aryl, substituted or unsubstituted heteroaryl, substituted or unsubstituted alkaryl, or substituted or unsubstituted aralkyl.

Yet another example of a geminal bisphosphonic acid group may have the formula —X—Sp—(CH₂)ₙCQ(PO₃H₂)₂, or may be partial esters thereof or salt thereof, wherein X, Q, and n are as described above. “Sp” is a spacer group, which, as used herein, is a link between two groups. Sp can be a bond or a chemical group. Examples of chemical groups include, but are not limited to, —CO₂—, —O₂C—, —CO—, —OSO₂—, —SO₃—, —SO₂—, —SO₂C₂H₄O—, —SO₂C₂H₄S—, —SO₂C₂H₄NR″—, —O—, —S—, —NR″—, —NR″CO—, —CONR″—, —NR″CO₂—, —O₂CNR″—, —NR″CONR″—, —N(COR″)CO—, —CON(COR″)—, —NR″COCH(CH₂CO₂R″)— and cyclic imides therefrom, —NR″COCH₂CH(CO₂R″)— and cyclic imides therefrom, —CH(CH₂CO₂R″)CONR″— and cyclic imides therefrom, —CH(CO₂R″)CH₂CONR″ and cyclic imides therefrom (including phthalimide and maleimides of these), sulfonamide groups (including —SO₂NR″— and —NR″SO₂— groups), arylene groups, alkylene groups and the like. R″, which can be the same or different when multiple are included, represents H or an organic group such as a substituted or unsubstituted aryl or alkyl group. In the example formula —X—Sp—(CH₂)ₙCQ(PO₃H₂)₂, the two phosphonic acid groups or partial esters or salts thereof are bonded to X through the spacer group Sp. Sp may be —CO₂—, —O₂C—, —O—, —NR″—, —NR″CO—, or —CONR″—, —SO₂NR″—, —SO₂CH₂CH₂NR″—, —SO₂CH₂CH₂O—, or —SO₂CH₂CH₂S— wherein R″ is H or a C₁-C₆ alkyl group.

Still a further example of a geminal bisphosphonic acid group may have the formula —N—[(CH₂)ₘ(PO₃H₂)]₂, partial esters thereof, or salts thereof, wherein m, which can be the same or different, is 1 to 9. In specific examples, m is 1 to 3, or 1 or 2. As another example, the organic group may include at least one group having the formula —(CH₂)n-N—[(CH₂)ₘ(PO₃H₂)]₂, partial esters thereof, or salts thereof, wherein n is 0 to 9, such as 1 to 9, or 0 to 3, such as 1 to 3, and m is as defined above. Also, the organic group may include at least one group having the formula —X—(CH₂)ₙ—N—[(CH₂)ₘ(PO₃H₂)]₂, partial esters thereof, or salts thereof, wherein X, m, and n are as described above, and, in an example, X is an arylene group. Still further, the organic group may include at least one group having the formula —X—Sp—(CH₂)ₙ—N—[(CH₂)ₘ(PO₃H₂)]₂, partial esters thereof, or salts thereof, wherein X, m, n, and Sp are as described above.

Yet a further example of a geminal bisphosphonic acid group may have the formula —CR═C(PO₃H₂)₂, partial esters thereof, or salts thereof. In this example, R can be H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. In an example, R is H, a C₁-C₆ alkyl group, or an aryl group.

The organic group may also include more than two phosphonic acid groups, partial esters thereof, or salts thereof, and may, for example include more than one type of group (such as two or more) in which each type of group includes at least two phosphonic acid groups, partial esters thereof, or salts thereof. For example, the organic group may include a group having the formula —X—[CQ(PO₃H₂)₂]_{P}, partial esters thereof, or salts thereof. In this example, X and Q are as described above. In this formula, p is 1 to 4, e.g., 2.

In addition, the organic group may include at least one vicinal bisphosphonic acid group, partial ester thereof, or salts thereof, meaning that these groups are adjacent to each other. Thus, the organic group may include two phosphonic acid groups, partial esters thereof, or salts thereof bonded to adjacent or neighboring carbon atoms. Such groups are also sometimes referred to as 1,2-diphosphonic acid groups, partial esters thereof, or salts thereof. The organic group including the two phosphonic acid groups, partial esters thereof, or salts thereof may be an aromatic group or an alkyl group, and therefore the vicinal bisphosphonic acid group may be a vicinal alkyl or a vicinal aryl diphosphonic acid group, partial ester thereof, or salts thereof. For example, the organic group may be a group having the formula —C₆H₃—(PO₃H₂)₂, partial esters thereof, or salts thereof, wherein the acid, ester, or salt groups are in positions ortho to each other.

In other examples, the ionic or ionizable group (of the organic group attached to the pigment) is a sulfur-containing group. The at least one sulfur-containing group has at least one S═O bond, such as a sulfinic acid group or a sulfonic acid group. Salts of sulfinic or sulfonic acids may also be used, such as —SO₃⁻X⁺, where X is a cation, such as Na⁺, H⁺, K⁺, NH₄⁺, Li⁺, Ca²⁺, Mg⁺, etc.

When the ionic or ionizable group is a carboxylic acid group, the group may be COOH or a salt thereof, such as —COO⁻X⁺, —(COO⁻X⁺)₂, or —(COO⁻X⁺)₃.

In still other examples, the organic group includes the aromatic group and the ionic or ionizable group. As one example, the organic group may be a phenol, where the ionic or ionizable group is the hydroxyl (OH) group. As another example, the organic group may be a benezenediol, such as resorcinol or catechol. Yet another example of a benzenediol that includes the alkyl group is hydroquinone.

When the ionic or ionizable group is the cationically charged ionic group or the cationically chargeable ionizable group, the group may be a quaternary ammonium salt; a primary amine; a secondary amine; a tertiary amine; a pyridinium salt; derivatives thereof; or mixtures thereof. Some specific examples of the organic group including the cationically charged ionic group or a cationically chargeable ionizable group include —C₆H₄N(CH₃)₃⁺Y⁻, —C₆H₄COCH₂N(CH₃)₃ ⁺Y⁻, —C₆H₄NC5H5)⁺Y⁻, —(C5H4N)C₂H5 ⁺Y⁻, —C₆H₄COCH₂ (NC5H5)⁺Y⁻, —(C5H4N)CH₃ ⁺Y⁻, and —C₆H₄CH₂N(CH₃)₃⁺Y⁻, wherein Y— is the corresponding counter-anion (e.g., formed from at least one hydroxy acid).

Examples of the self-dispersed pigments are commercially available as dispersions. Suitable commercially available self-dispersed pigment dispersions include those of the CAB-O-JET® 200 Series, manufactured by Cabot Corporation. Some specific examples include CAB-O-JET® 200 (black pigment), CAB-O-JET® 250C (cyan pigment), CAB-O-JET® 260M or 265M (magenta pigment) and CAB-O-JET® 270 (yellow pigment)). Other suitable commercially available self-dispersed pigment dispersions include those of the CAB-O-JET® 400 Series, manufactured by Cabot Corporation. Some specific examples include CAB-O-JET® 400 (black pigment), CAB-O-JET® 450C (cyan pigment), CAB-O-JET® 465M (magenta pigment) and CAB-O-JET® 470Y (yellow pigment)). Still other suitable commercially available self-dispersed pigment dispersions include those of the CAB-O-JET® 300 Series, manufactured by Cabot Corporation. Some specific examples include CAB-O-JET® 300 (black pigment) and CAB-O-JET® 352K (black pigment).

In other examples, the colorant 10 of the inkjet ink composition is a dye. The dye may be non-ionic, cationic, anionic, or a combination thereof. Examples of dyes that may be used include Sulforhodamine B, Acid Blue 113, Acid Blue 29, Acid Red 4, Rose Bengal, Acid Yellow 17, Acid Yellow 29, Acid Yellow 42, Acridine Yellow G, Acid Yellow 23, Acid Blue 9, Nitro Blue Tetrazolium Chloride Monohydrate or Nitro BT, Rhodamine 6G, Rhodamine 123, Rhodamine B, Rhodamine B Isocyanate, Safranine O, Azure B, and Azure B Eosinate, which are available from Sigma-Aldrich Chemical Company (St. Louis, Mo.). Examples of anionic, water-soluble dyes include Direct Black 168, Direct Yellow 132, Direct Blue 199, Acid Yellow 23, Magenta 377 (available from Ilford AG, Switzerland), alone or together with Acid Red 52. Examples of water-insoluble dyes include azo, xanthene, methine, polymethine, and anthraquinone dyes. Specific examples of water-insoluble dyes include Orasol® Blue GN, Orasol® Pink, and Orasol® Yellow dyes available from Ciba-Geigy Corp. Black dyes may include Direct Black 154, Fast Black 2, Direct Black 171, Direct Black 19, Acid Black 1, Acid Black 191, Mobay Black SP, and Acid Black 2.

The colorant 10 in the shipping fluid composition is a dye that exhibits the absorbance as described herein.

In an example, the dye is a fluorophore that absorbs far red/infrared light, fluorophores that absorb far ultraviolet light, or mixtures thereof. The term “fluorophore” includes compounds capable of absorbing light and thereafter emitting fluorescent light upon excitation with light of a given wavelength.

In some examples, fluorophores that absorb far red/infrared light include uncomplexed metal phthalocyanines and uncomplexed metal naphthalocyanines and their salts. Phthalocyanines generally include four isoindole groups (e.g., [(C₆H₄)C₂N]) which are linked together to form a complex conjugated structure. Naphthalocyanines generally include eight isoindole groups (e.g., [(C₆H₄)C₂N]) which are also linked together to form a complex conjugated structure. Metal phthalocyanines and metal naphthalocyanines contain one or more metal atoms.

The term “uncomplexed” includes dyes that are not chemically linked to any compounds (especially polymeric compounds) and do not form any dye complexes. This increases the compatibility of the shipping fluid composition across many different printing systems with high reliability levels.

In some examples, the dye in the shipping fluid composition can include tetrasulfonated aluminum phthalocyanine, C.I. Acid Red 52, C.I. Acid Red 7, or mixtures thereof. In some examples, the dye in the shipping fluid composition can include an invisible metal (e.g., aluminum) phthalocyanine fluorophoric uncomplexed dye (e.g., chloroaluminum (III) phthalocyanine tetrasulfonic acid or salts thereof).

In some examples, the dye in the shipping fluid composition can include metal phthalocyanines e.g., “The Phthalocyanines,” Vol. 1, Frank Moser and Arthur Thomas, CRC Press. Such other metal phthalocyanines include zinc, cadmium, tin, magnesium, and europium.

In some examples, the dye in the shipping fluid composition can include metal naphthalocyanines. Some examples of the metal naphthalocyanines may be copper(II) 2,3-naphthalocyanine, cobalt(II) 2,3-naphthalocyanine, tin(II) 2,3-naphthalocyanine, nickel(II) 2,3-naphthalocyanine, zinc 2,11,20,29-tetra-tert-butyl-2,3-naphthalocyanine, silicon 2,3-naphthalocyanine bis(trihexylsilyloxide), nickel(II) 5,9,14,18,23,27,32,36-octabutoxy-2,3-naphthalocyanine.

In some examples, the dye in the shipping fluid composition can include a phthalocyanine fluorophore, which is chloroaluminum (III) phthalocyanine tetrasulfonic acid or salts thereof, an ultraviolet fluorophore comprised of benzenesulfonic acid-2,2′-(1,2-ethenediyl)bis[5-[4-bis(2-hydroxyethyl)amino]-6-[(4-sulfoph enyl)amino]-1,3,5-triazin-2yl]amino-tetrasodium salt, or mixtures thereof. In some examples, ultraviolet fluorophores can be selected from the group consisting of ultraviolet absorbing stilbenes, pyrazolines, coumarins, carbostyrils, pyrenes, and mixtures thereof. Examples of stilbenes include 4,4′-bis(triazin-2-ylamino)stilbene-2,2′-disulfonic acid; benzenesulfonic acid-2,2′-(1,2-ethenediyl)bis[5-[4-bis(2-hydroxyethyl)amino]-6-[(4-sulfoph enyl)amino]-1,3,5-triazin-2yl]amino-tetrasodium salt; 4,4-bis [4-diisopropanolamino-6-(p-sulfoanilino)-s-triazin-2-yl-amine]stilbene-sodium disulfonate; or mixtures thereof. An example of pyrazoline includes 1,2-diphenyl-2-pyrazoline. Examples of coumarins include 7-diethylamino-4-methylcoumarin; 7-hydroxy-4-methylcoumarin; 3-(2-benzimidazolyl)-7-(diethylamino)coumarin; or mixtures thereof. An example of carbostyrils includes 2-hydroxyquinoline. An example of pyrenes include N-(1-pyrenebutanoyl)cysteic acid.

In some examples, the ultraviolet fluorophores can include dibenzothiophene-5,5-dioxide, C.I. Fluorescent Brightener 28, C.I. Fluorescent Brightener 220, C.I. Fluorescent Brightener 264, or mixtures thereof. The foregoing ultraviolet fluorophores and others are commercially available from numerous sources including but not limited to the Aldrich Chemical Co. of Milwaukee, Wis. (USA); Bayer Corporation of Pittsburgh, Pa. (USA) under the names BLANKOPHORE® or PHORWHITE®; Ciba-Geigy Corporation of Greensboro, N.C. (USA)/Basil, Switzerland; Molecular Probes of Eugene, Oreg. (USA); Sandoz Chemicals of Charlotte, N.C. (USA) under the name LEUKOPHOR®; and Sigma Co. of St. Louis, Mo. (USA). These ultraviolet fluorophores are characterized by their ability to generate fluorescent light upon ultraviolet illumination as discussed above, which can be seen by the unaided eye.

In some examples, the dye in the shipping fluid composition is tetrasulfonated aluminum phthalocyanine (TINOLUX® BBS from BASF Corp.), C.I. Acid Red 52, C.I. Acid Red 7, or mixtures thereof.

The inkjet composition 20 (i.e., the inkjet ink composition or the shipping fluid composition) disclosed herein also includes a density modifier 12. In the inkjet ink composition including pigment, the density modifier 12 is a component that helps to reduce pigment settling. It is believed the density modifier 12 controls the sedimentation rate by increasing the density of the aqueous vehicle and thus reducing the difference between the pigment density and the vehicle (medium) density. In the inkjet ink composition including the dye, the density modifier 12 is a component that may result in a higher drop weight without also increasing the drop volume. The higher drop weight may lead to a higher momentum for the same drop volume. The higher momentum may lead to improved decap performance, which may improve nozzle health.

The density modifier 12 is selected from the group consisting of a triiodo amino derivative of isophthalic acid, a mixture of polysucrose and sodium diatrizoate, colloidal silica particles coated with polyvinylpyrrolidone, and combinations thereof. In some instances, one density modifier 12 is used. In other instances, more than one of the density modifiers listed above is used in the inkjet composition 20.

In a specific example, the density modifier 12 is the triiodo amino derivative of isophthalic acid. The triiodo amino derivative of isophthalic acid is selected from the group consisting of diatrizoate, iodixanol, iohexol, deacetyliodixanol, iopamidol, ioxilan, ioversol, iomeprol, iobitridol, iopentol, ioforminol, iopiperidol, iosimenol, and combinations thereof.

The triiodo amino derivative of isophthalic acid may be synthesized via methods known in the art, or it may be commercially available. Some commercially available triiodo amino derivatives of isophthalic acid include GASTROGRAFIN™, available from Bracco Diagnostics Inc (a diatrizoate meglumine and diatrizoate sodium solution), OPTIPREP™, available from Cosmo Bio USA (an iodixanol solution), OMNIPAQUE™, available from GE Healthcare (an iohexol solution), catalog number D198945, available, e.g., from Toronto Research Chemicals (a deacetyl iodixanol solution), ISOVUE™, available from Bracco Diagnostics Inc. (an iopamidol solution), OXILAN™, available from BLD Pharmatech Ltd. (an ioxilan solution), OPTIRAY™, available from Guerbet LLC (an ioversol solution), IOMERON™, available from Bracco Diagnostics Inc. (an iomeprol solution), XENETIX™, available from Guerbet LLC (an iobitridol solution), CS-T-29808, available from ClearSynth Canada Inc. (an iopentol solution), CAS #1095110-48-7, available from Smolecules Inc. (an ioforminol powder), CAS #181872-90-2, available from Smolecules Inc. (an iosimenol powder).

In another specific example, the density modifier 12 is a mixture of polysucrose and sodium diatrizoate. Examples of a solution with a mixture of polysucrose and sodium diatrizoate are HISTODENZ™ and HISTOPAQUE™, available from Sigma Aldrich.

In another specific example, the density modifier 12 is a solution with colloidal silica particles coated with polyvinylpyrrolidone. An example of a commercially available solution with colloidal silica particles coated with polyvinylpyrrolidone is PERCOLL™, available from Sigma Aldrich.

In some examples, the density modifier 12 is present in the inkjet composition 20 in an amount ranging from about 2 wt % active to about 10 wt % active, based on the total weight of the inkjet composition 20. When more than one density modifier 12 is used, the total amount of density modifier 12 present in the inkjet composition 20 ranges from about 2 wt % active to about 10 wt % active.

In a specific example, the density modifier 12 is the triiodo amino derivative of isophthalic acid. In another specific example, the triiodo amino derivative of isophthalic acid is iodixanol; and the density modifier 12 is present in an amount ranging from about 2 wt % active to about 9 wt % active based on a total weight of the inkjet composition 20.

The inkjet composition 20 further includes an aqueous vehicle 14. The aqueous vehicle 14 may consist of water and a co-solvent. In other examples, the aqueous vehicle 14 may consist of water, a co-solvent, and an additive selected from the group consisting of a surfactant, an anti-kogation agent, an anti-decel agent, an antimicrobial agent, and combinations thereof.

A suitable co-solvent for the inkjet composition may be a water soluble or a water miscible co-solvent. Examples of co-solvents include alcohols, amides, esters, ketones, lactones, and ethers. In additional detail, the co-solvent may include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers (e.g., Dowanol™ TPM (from Dow Chemical), higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of alcohols may include ethanol, isopropyl alcohol, butyl alcohol, and benzyl alcohol. Other specific examples include 2-ethyl-2-(hydroxymethyl)-1,3-propane diol (EPHD), dimethyl sulfoxide, sulfolane, and/or alkyldiols such as 1,2-hexanediol.

The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2-hexanediol, 1,2,6-hexanetriol, glycerin, trimethylolpropane, and xylitol. Examples of polyhydric alcohol derivatives may include an ethylene oxide adduct of diglycerin.

The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

The co-solvent(s) may be present in the inkjet composition 20 in an amount ranging from about 4 wt % active to about 55 wt % active (based on the total weight of the inkjet composition 20). In an example, the total amount of co-solvent(s) present in the inkjet composition is about 10 wt % active (based on the total weight of the inkjet composition 20).

In some examples, the aqueous vehicle 14 may include a surfactant. Suitable surfactants may be any non-ionic surfactant, cationic surfactant or anionic surfactant. The non-ionic surfactant may be used with any of the pigment dispersions disclosed herein. The cationic surfactant may be suitable for use with a cationic pigment dispersion, and the anionic surfactant may be suitable for use an anionic pigment dispersion.

Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; and biosurfactants such as spiculisporic acid, rhamnolipid, and lysolecithin.

One specific example is polyoxyethylene (10) oleyl ether, such as BRIJ® O10 (Croda Int.). More specific examples of non-ionic surfactant include a silicone-free alkoxylated alcohol surfactant such as, for example, TEGO® Wet 510 (Evonik Degussa) and/or a self-emulsifiable wetting agent based on acetylenic diol chemistry, such as, for example, SURFYNOL® SE-F (Evonik Degussa). Other suitable commercially available non-ionic surfactants include SURFYNOL® 465 (ethoxylated acetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Evonik Degussa); Tergitol® TMN-3 and Tergitol® TMN-6 (both of which are branched secondary alcohol ethoxylate, non-ionic surfactants), and Tergitol® 15-S-3, Tergitol® 15-S-5, and Tergitol® 15-S-7 (each of which is a secondary alcohol ethoxylate, non-ionic surfactant) (all of the Tergitol® surfactants are available from The Dow Chemical Company); and BYK® 345, BYK® 346, BYK® 347, BYK® 348, BYK® 349 (each of which is a silicone surfactant) (all of which are available from BYK).

Examples of the cationic surfactant include quaternary ammonium salts, such as benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, domiphen bromide, alkylbenzyldimethylammonium chlorides, distearyldimethylammonium chloride, diethyl ester dimethyl ammonium chloride, dipalmitoylethyl hydroxyethylmonium methosulfate, and ACCOSOFT® 808 (methyl (1) tallow amidoethyl (2) tallow imidazolinium methyl sulfate available from Stepan Company). Other examples of the cationic surfactant include amine oxides, such as lauryldimethylamine oxide, myristamine oxide, cocamine oxide, stearamine oxide, and cetamine oxide.

Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsul fonate, and dibutylphenylphenol disulfonate.

In any of the examples disclosed herein, the surfactant may be present in the inkjet composition 20 in an amount ranging from about 0.005 wt % active to about 3 wt % active (based on the total weight of the inkjet composition 20), whether a single surfactant is used or a combination of surfactants is used. In an example, the surfactant(s) is present in the inkjet composition 20 in an amount ranging from about 0.008 wt % active to about 2.5 wt % active, based on the total weight of the inkjet composition 20. In another example, the surfactant is present in the inkjet composition 20 in an amount of about 0.3 wt % active, based on the total weight of the inkjet composition 20.

The aqueous vehicle 14 may also include anti-kogation agent(s). Kogation refers to the deposit of dried printing liquid on a heating element of a thermal inkjet printhead. Anti-kogation agent(s) is/are included to assist in preventing the buildup of kogation. In some examples, the anti-kogation agent may improve the jettability of the inkjet composition 20. The anti-kogation agent(s) may be present in the inkjet composition 20 in a total amount ranging from about 0.1 wt % active to about 1.5 wt % active, based on the total weight of the inkjet composition 20. In an example, the anti-kogation agent(s) is/are present in an amount of about 0.5 wt % active, based on the total weight of the inkjet composition 20.

Examples of suitable anti-kogation agents include oleth-3-phosphate (commercially available as CRODAFOS™ 03A or CRODAFOS™ N-3A), oleth-5-phosphate (commercially available as CRODAFOS™ O5A), or dextran 500k. Other suitable examples of the anti-kogation agents include CRODAFOS™ HCE (phosphate-ester from Croda Int.), CRODAFOS™ CES (phosphate-based emulsifying and conditioning wax from Croda Int.), CRODAFOS® N10 (oleth-10-phosphate from Croda Int.), or Dispersogen® LFH (polymeric dispersing agent with aromatic anchoring groups, acid form, anionic, from Clariant), etc. It is to be understood that any combination of the anti-kogation agents listed may be used.

The aqueous vehicle 14 may also include anti-decel agent(s). The anti-decel agent may function as a humectant. Decel refers to a decrease in drop velocity over time with continuous firing. In the examples disclosed herein, the anti-decel agent(s) is/are included to assist in preventing decel. In some examples, the anti-decel agent may improve the jettability of the inkjet composition 20. An example of a suitable anti-decel agent is ethoxylated glycerin having the following formula:

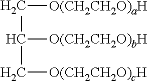

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Vantage Specialty Chemicals).

The anti-decel agent(s) may be present in the inkjet composition 20 in an amount ranging from about 0.2 wt % active to about 5 wt % active (based on the total weight of the inkjet composition 20). In an example, the anti-decel agent is present in the inkjet composition 20 in an amount of about 1 wt % active, based on the total weight of the inkjet composition 20.

The aqueous vehicle 14 may also include antimicrobial agent(s). Antimicrobial agents are also known as biocides and/or fungicides. Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

In an example, the total amount of antimicrobial agent(s) in the inkjet composition 20 ranges from about 0.01 wt % active to about 0.5 wt % active (based on the total weight of the inkjet composition 20). In another example, the total amount of antimicrobial agent(s) in the inkjet composition 20 is about 0.15 wt % active (based on the total weight of the inkjet composition).

When the inkjet composition 20 is the shipping fluid composition, the aqueous vehicle 14 may also include at least one carbohydrate-containing solvent 16. In these examples, the aqueous vehicle 14 may be referred to herein as an aqueous shipping fluid vehicle. The carbohydrate-containing solvent 16 may be any of the solvents listed above, with the addition of at least one carbohydrate. The carbohydrate is selected from the group consisting of monosaccharides, monosaccharide derivatives, disaccharides, disaccharide derivatives, trisaccharides, trisaccharide derivatives, oligosaccharides, oligosaccharide derivatives, polysaccharides, polysaccharide derivatives, and mixtures thereof. In these examples, the carbohydrate is present in an amount of about 10% or more, based on the total weight of the carbohydrate-containing solvent 16.

In some examples, the carbohydrate-containing solvent 16 includes the carbohydrate, which is selected from the group consisting of sorbitol, glucose, fructose, sucrose, sucralose, and mixtures thereof. In a specific example, a mixture consisting of glucose and fructose—i.e., corn syrup—is used. An example of corn syrup is CORNSWEET® 90 (i.e., mixtures of about 90 wt % fructose, 9 wt % glucose, and 1 wt % higher saccharides), which is available from the Archer Daniels Midland Company.

The carbohydrate-containing solvent 16 can be present in an amount ranging from about 15 wt % active to about 50 wt % active based on a total weight of the inkjet composition 20 (specifically the shipping fluid composition). In some examples, the carbohydrate-containing solvent 16 can be present in an amount of from about 18 wt % to about 40 wt % based on the total weight of the shipping fluid composition. In some examples, the carbohydrate-containing solvent 16 can be present in an amount of from about 20 wt % to about 38 wt % based on the total weight of the shipping fluid composition.

The viscosity of the inkjet composition 20 may vary depending upon the application method that is to be used to apply the inkjet composition 20. When the inkjet composition 20 is to be applied with a piezoelectric inkjet applicator/printhead, the viscosity of the inkjet composition 20 may range from about 1 cP to about 20 cP (at 20° C. to 25° C. and a shear rate of about 3,000 Hz). When the inkjet composition 20 is to be applied with a thermal inkjet applicator/printhead, the inkjet composition has a viscosity ranging from about 1 cP to about 7 cP (at 20° C. to 25° C. and a shear rate of about 3,000 Hz).

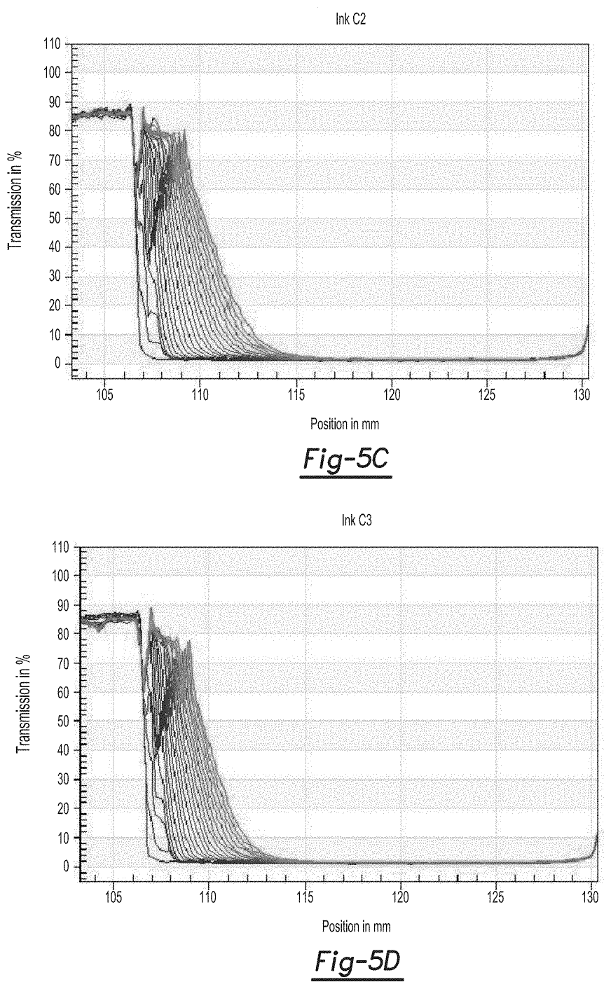

The density of the inkjet composition 20 may vary depending upon the colorant 10 in the composition and the amount of the density modifier 12 that is used. In some instances, the colorant 10 used in the inkjet composition will have a first density, and the aqueous vehicle will have a second density that is lower than the first density. The addition of the density modifier 12 to the inkjet composition 10 decreases the difference between the first density and the second density. In pigmented inkjet ink compositions, decreasing the difference in the first and second densities can help to reduce pigment settling. An example of a method for reducing pigment settling is shown schematically in FIG. 4. In this example, the method 400 includes incorporating a colorant having a first density into an aqueous vehicle having a second density that is lower than the first density (shown at step 402), and adding a density modifier to the aqueous vehicle that reduces a difference between the first density and the second density, the density modifier being selected from the group consisting of a triiodo amino derivative of isophthalic acid, a mixture of polysucrose and sodium diatrizoate, colloidal silica particles coated with polyvinylpyrrolidone, and combinations thereof (shown generally at step 404). In some instances, such as when the colorant is a pigment, the density of the pigment ranges from about 1.4 g/cm³ to about 1.6 g/cm³; and the density of the inkjet composition ranges from about 1.0 g/cm³ to about 1.2 g/cm³ (i.e., the density of the aqueous vehicle after the pigment and density modifier have been added). In other instances, the colorant is a dye, and the density of the dye ranges from about 1.1 g/cm³ to about 1.4 g/cm³, and the density of the dye based inkjet ink composition or the shipping fluid composition ranges from about 1.0 g/cm³ to about 1.2 g/cm³ (i.e., the density of the aqueous vehicle after the dye and the density modifier have been added). In any of the examples, the density modifier decreases the difference between the first and second density, without detrimentally affecting the viscosity of the inkjet composition 20.

Printing Method(s)

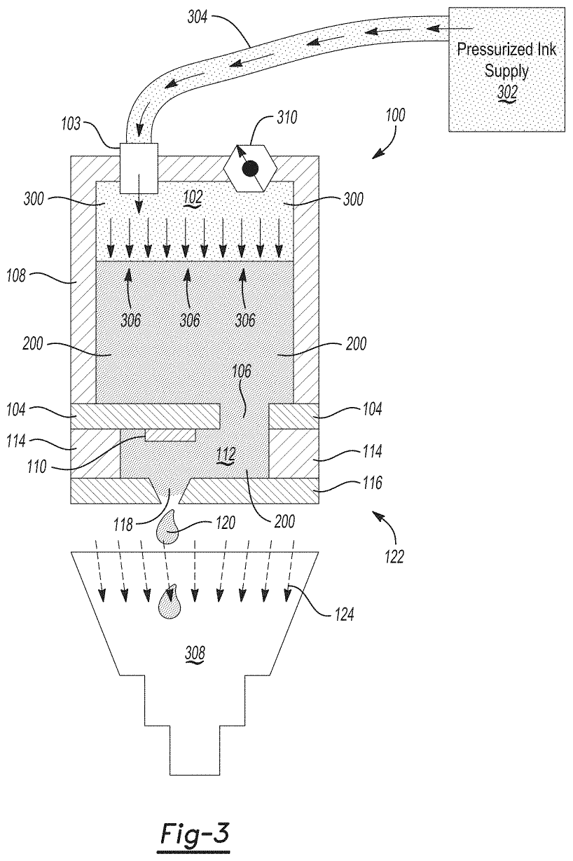

In FIG. 2, a printing method is described. The printing method 50 can include inkjet printing an inkjet ink composition onto at least a portion of a substrate, the inkjet ink composition including a pigment; a density modifier selected from the group consisting of a triiodo amino derivative of isophthalic acid, a mixture of polysucrose and sodium diatrizoate, colloidal silica particles coated with polyvinylpyrrolidone, and combinations thereof; and an aqueous ink vehicle. In some examples of the printing method 50, the inkjet ink composition is inkjet printed from an inkjet printer; and prior to inkjet printing the inkjet ink composition, the method further includes printing a shipping fluid composition from a pen of the inkjet printer, the shipping fluid composition including an optional dye, at least one carbohydrate-containing solvent present in an amount ranging from about 15 wt % active to about 50 wt % active based on a total weight of the shipping fluid composition, a density modifier selected from the group consisting of a triiodo amino derivative of isophthalic acid, a mixture of polysucrose and sodium diatrizoate, colloidal silica particles coated with polyvinylpyrrolidone, and combinations thereof, and an aqueous shipping fluid vehicle; and introducing an inkjet supply containing the inkjet ink composition in fluid communication with the pen of the inkjet printer.

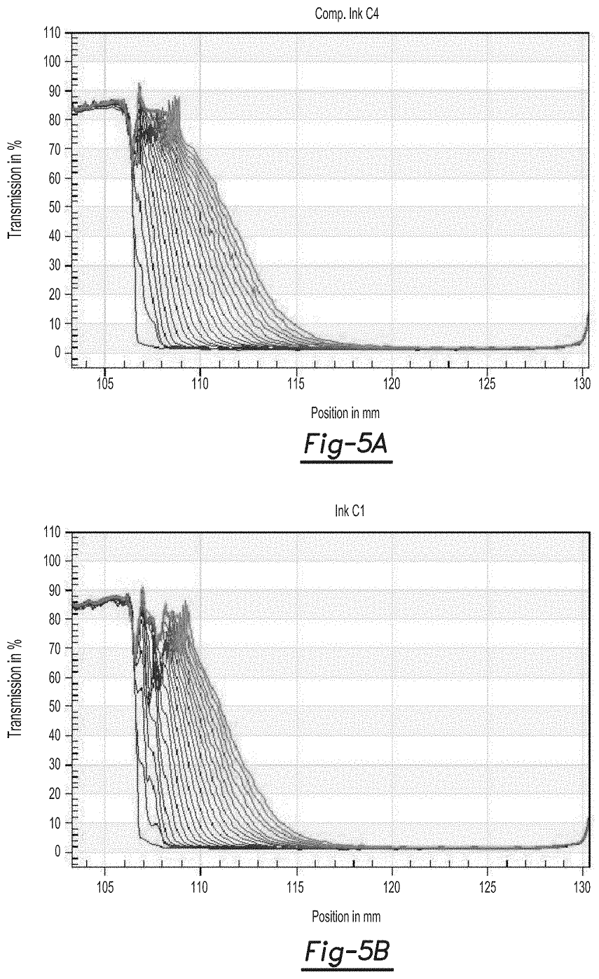

A schematic example of a pen 100 that may be used in the printing method 50 can be found in FIG. 3.

FIG. 3 shows an example of an inkjet pen 100 (sometimes referred to as an inkjet cartridge) that may incorporate an inkjet composition 20 or multiple inkjet compositions 20 described above. A fluid reservoir 102 in the body of pen 100 is configured to hold fluid such as ink and/or shipping fluid. Depending on the particular pen device utilized, fluid port 103 facilitates the flow of fluid through the pen 100 either through communication with exterior air or through communication with an external ink supply 302 through connection to a tube 304. In some cases, the pen 100 includes a self-contained supply of ink, and in these cases the fluid port 103 facilitates the flow of the ink through the pen 100 through communication with exterior air which is drawn into the pen 100 as ink exits the other side of the pen 100 as discussed below. In cases when the pen 100 is coupled to an external ink supply 302, fluid port 103 facilitates the flow of ink through the pen 100 through communication with the external supply 302 via a tube 304, which carries ink under pressure from the supply to the pen.

The fluid reservoir 102 is fluidically coupled to an intermediate member 104 via fluid inlet passage 106. Depending on the particular pen device utilized, generally, intermediate member 104 is attached to the pen body 108. In other examples, the intermediate member 104 may include integrated circuitry and may be mounted to what is commonly referred to as a chip carrier (not shown), which is attached to the pen body 108. The intermediate member 104 generally contains an energy-generating element or fluid ejector 110 that generates a force utilized to eject a drop 120 of fluid held in firing chamber 112. Fluid or drop ejector 110 creates a discrete number of drops of a substantially fixed size or volume.

Two widely used energy generating elements are thermal resistors and piezoelectric elements. A thermal resistor rapidly heats a component in the fluid above its boiling point causing vaporization of the fluid component resulting in ejection of a drop 120 of the fluid. A piezoelectric element utilizes a voltage pulse to generate a compressive force on the fluid resulting in ejection of a drop 120 of the fluid. Although pen 100 is described as employing an ink drop generator that creates generally fixed-sized drops that are discretely ejected, other pen types or fluid ejection devices are contemplated, such as those having hydraulic, air assisted, or ultrasonic nozzles that may form a spray of fluid having varying drop sizes.

The intermediate member 104, chamber layer 114, nozzle layer 116 (nozzle plate), nozzle(s) 118, and a flexible circuit (not shown) form what is generally referred to as a printhead 122. The chamber layer 114 forms the side walls of chamber 112, and intermediate member 104 and nozzle layer 116 form the bottom and top of chamber 112 respectively, where the intermediate member 104 is considered the bottom of the chamber 112. The pen 100 typically has a nozzle density on the order of 300 nozzles per inch, but in alternate examples may have nozzle densities that range from a single nozzle up to over a 1000 nozzles per inch. In addition, although pen 100 of FIG. 3 illustrates a nozzle layer 116 having a single nozzle 118 per fluid ejector 110 through which fluid is ejected, in alternate example, each fluid ejector 110 may utilize multiple nozzles 118 through which fluid is ejected. Each activation of a fluid ejector 110 results in the ejection of a precise quantity of fluid in the form of a fluid drop 120 with the drop 120 ejected substantially along fluid ejection axis 124.

In an example, a shipping fluid composition 200 (as described herein) fills the chamber 112. The shipping fluid composition 200 has a density that is different than the density of an inkjet ink composition 300 (as described herein) that will eventually fill the pen 100 and be ejected onto media (e.g., a substrate) in a printing operation. In some examples, the shipping fluid composition 200 has a significantly higher density than the inkjet ink composition 300 to be used in pen 100. Although other density differentials between the shipping fluid composition 200 and inkjet ink composition 300 are contemplated, the density differential in the present example is about 0.1 grams to about 0.4 grams per cubic centimeter (0.1-0.4 g/cm³).

FIG. 3 illustrates that when the pen 100 is installed in a printer, the fluid port 103 is coupled to an external, pressurized ink supply 302 through tube 304, although sometimes the ink is self-contained, as described above. After installation, a purge/refill process is performed to expel the shipping fluid composition 200 from the pen 100 and printhead 122 and refill them with the inkjet ink composition 300. When the pen 100 is filled from top to bottom as discussed further below, the amount of mixing that occurs is limited due to the differential densities in the shipping fluid composition 200 and the inkjet ink composition 300. This essentially achieves a “plug flow” of the shipping fluid composition 200 and ink fronts 306.

The process of purging the shipping fluid composition 200 from the pen 100 and refilling it with the inkjet ink composition 300 can occur in several ways, and may depend in part on the configuration of pen 100. More specifically, for example, how the pen 100 is purged of the shipping fluid composition 200 and how, or if, the pen 100 is refilled with the inkjet ink composition 300 may depend on whether the pen 100 has a self-contained ink supply or whether the pen 100 relies on an external ink supply 302 as shown in FIG. 3. Since the pen 100 shown in FIG. 3 is completely filled with shipping fluid composition 200 during manufacturing, the purge process includes a corresponding refilling of the pen 100 with inkjet ink composition 300. As noted above, upon installation of pen 100 in a printer, fluid port 103 is coupled to an external, pressurized ink supply 302 through tube 304.

At least two possible methods of purging the shipping fluid 200 from pen 100 are illustrated in FIG. 3. In a first method, the shipping fluid composition 200 is drawn out of the nozzle(s) 118 through the use of a vacuum source 308 applied to the nozzle layer 116. In this process, the shipping fluid composition 200 is sucked out of pen 100 through nozzle(s) 118 as inkjet ink composition 300 fills the pen 100 from the top through fluid port 103. In another method, the shipping fluid composition 200 is expelled from the pen 100 through the process of blow priming. In the blow priming process, a back pressure that normally keeps ink from dripping out of the pen 100 is released by a pressure regulation system 310. Once the pressure regulation system 310 releases the back pressure, the pressurized ink supply 302 forces the shipping fluid composition 200 out of the pen 100 through nozzle(s) 118 while refilling the pen with the inkjet ink composition 300.

In another method, the shipping fluid composition 200 is expelled from the pen 100 through the normal process of “spitting” through nozzle(s) 118. “Spitting” is used both when printing an image onto media and/or when performing a maintenance operation on the printhead. As noted above, fluid ejector 110 (e.g., a thermal resistor or piezoelectric element) generates a force utilized to eject a drop 120 of fluid held in firing chamber 112. This ejection process is known as spitting, and it is used to form an image on a print substrate, such as paper. In addition, during normal printing operations, ink is repeatedly ejected from the nozzle(s) 118 to form images. This ink can build up over time on a surface of the nozzle 118 and/or nozzle plate 116. The buildup can interfere with the ejection of ink droplets and reduce print quality. A maintenance operation is sometimes performed that includes both spitting and wiping away residual ink left on the nozzle(s) 118 and/or nozzle plate 116 to help prevent this problem. Thus, spitting can also be used to purge the shipping fluid composition 200 from pen 100 as air is allowed in through fluid port 103 to relieve negative pressure that would otherwise build up through the removal of the shipping fluid composition 200.

In still another method, purging the shipping fluid composition 200 from the pen 100 can be achieved using air that is introduced through the fluid port 103. This method is suitable for use with the self-contained ink supply. For example, the shipping fluid composition 200 can be drawn out of the nozzle(s) 118 through the use of a vacuum source 308 applied to the nozzle layer 116. In this process, shipping fluid composition 200 is sucked out of pen 100 through nozzle(s) 118 as air is allowed in through fluid port 103 (which would not be connected to an external ink supply 302). The air relieves the negative pressure that would otherwise be generated by the removal of shipping fluid composition 200.

In each of these purging methods, as noted above, the amount of mixing that occurs between the shipping fluid composition 200 and the inkjet ink composition 300 is limited due to their differential densities which create a “plug flow” of the shipping fluid and ink fronts 306.

In some examples, the inkjet ink composition disclosed herein can be used for printing when a printer containing the pen 100 is ready for use. In some instances, the pen 100 can be ready for use to print user images after the shipping fluid composition has been flushed out from the pen 100.

The pen 100 shown in FIG. 3 may also be used without the shipping fluid composition 200. In these examples, the inkjet ink composition 300 is dispensed from the pen 100 as described herein, and shipping fluid purging does not take place. In these examples, the inkjet ink composition 300 can be delivered from the supply 302, or it can be a self-contained ink supply.

In some examples, the substrate upon which the inkjet ink composition 300 is applied is a media or printing surface. In some examples, the substrate is paper. In some examples, the paper may be plain papers, microporous photopapers, coated papers, glossy photopapers, semi-gloss photopapers, heavy weight matte papers, billboard papers, digital fine art papers, calendared papers, or combinations thereof.

To further illustrate the present disclosure, examples are given herein. It is to be understood that these examples are provided for illustrative purposes and are not to be construed as limiting the scope of the present disclosure.

### EXAMPLES

Table 1 lists the ingredients used in the inks and/or comparative inks of Examples 1 and 2.

TABLE 1

| Ingredient | Nature of Ingredient | Supplier |
|---|---|---|
| 1-(2-hydroxyethyl)- | solvent | Sigma Aldrich |
| 2-pyrrolidone | | |
| (98%) | | |
| Glycerol (99%) | solvent | Sigma Aldrich |
| (i.e., 1,2,3-Propanetriol, | | |
| Glycerin) | | |
| SURFYNOL ® 104 | non-ionic surfactant | Evonik Ind. |
| BRIJ ® O10 | non-ionic surfactant | Croda |
| (PEG 10 Oleyl Ether) | | |
| ACTICIDE ® B20 (20%) | antimicrobial | Thor |
| (1,2-Benzisothiazolin-3-one) | | |
| Cyan Dispersion* | Cyan Pigment ** with | HP Inc. |
| | styrene acrylic | |
| | dispersant | |
| OPTIPREP ™ (60%) | density modifier | Sigma Aldrich |
| (iodixanol) | | |

*Centrifuged twice, volume weighted mean diameter (Mᵥ) ranged from 108 nm to 135 nm
** Pigment = PB 15:3 with a density ~1.6 g/cm³

### Example 1

Three cyan inks were prepared in accordance with the examples disclosed herein. Each of these inks included a different amount of the density modifier, iodixanol (OPTIPREP™ (60%)). A comparative example ink was also prepared. The comparative example ink did not include any of the density modifier. The formulations for the three examples inks (Inks C1-C3) and the comparative example ink (Comp. Ink C4) are shown in Table 2.

TABLE 2

| | | | | Comp. Ink |
|---|---|---|---|---|
| | Ink C1 | Ink C2 | Ink C3 | C4 |
| Ingredient | (wt % active) | (wt % active) | (wt % active) | (wt % active) |
| 1-(2-hydroxyethyl)- | 10 | 10 | 10 | 10 |
| 2-pyrrolidone (98%) | | | | |
| Glycerol (99%) | 10 | 10 | 10 | 10 |
| SURFYNOL ® 104 | 0.3 | 0.3 | 0.3 | 0.3 |
| BRIJ ® O10 | 0.5 | 0.5 | 0.5 | 0.5 |
| ACTICIDE ® B20 | 0.15 | 0.15 | 0.15 | 0.15 |
| (20%) | | | | |
| Cyan Dispersion | 3.56 | 3.56 | 3.56 | 3.56 |
| OPTIPREP ™ (60%) | 2 | 6 | 9 | 0 |
| Deionized Water | Balance | Balance | Balance | Balance |

The viscosity and density of each of the example and comparative example inks were measured. The viscosity was measured at 25° C. and 60 RPM using a Brookfield LVDV-II+ viscometer (with a 00 UL-ULA (0) adapter). The density was measured using a Densito Portable Density Meter, available from Mettler Toledo. These results are shown in Table 3.

TABLE 3

| | Viscosity | Density |
|---|---|---|
| INK ID | (cP) | (g/cm³) |
| Comp. Ink C4 | 3.26 | 1.07 |
| (0% OPTIPREP ™) | | |
| Ink C1 | 3.38 | 1.08 |
| (2% OPTIPREP ™) | | |
| Ink C2 | 3.73 | 1.10 |
| (6% OPTIPREP ™) | | |
| Ink C3 | 4.16 | 1.11 |
| (9% OPTIPREP ™) | | |

As depicted in Table 3, the density modifier increased both the density and the viscosity of the example inks compared Comp. Ink C4. The gap between the pigment density (˜1.6 g/cm³) and the ink density was decreased with an increased amount of the density modifier. Moreover, while the viscosity of the example inks increased compared Comp. Ink C4, the viscosities were still within thermally and piezoelectrically ink jettable viscosities.

The example and comparative example inks were also tested to determine the pigment settling rate. Each of the example ink and the comparative example ink was filled into a vial, and centrifuged using a LUMiSizer™ (LUMiFuge™ 114 from LUM GmbH). In this example, the LUMiSizer™ was operated at the following conditions: acceleration due to gravity (m/s²) was 9.8 and RCA @ 4000 RPM, in g was 2000 (2000 times compared to gravity). Centrifugation occurred at 100 second intervals for a 3 hour period. The transmittance of the samples through the vials was measured throughout centrifugation. As pigment settling and sedimentation occurs, the transmittance at the front/top (by the cap) of the vial increases and absorbance the back/bottom of the vial increases. The transmittance was measured along the length of the vial at various positions from the front/top. A higher transmittance at a position further from the front/top indicates higher pigment settling and sedimentation.

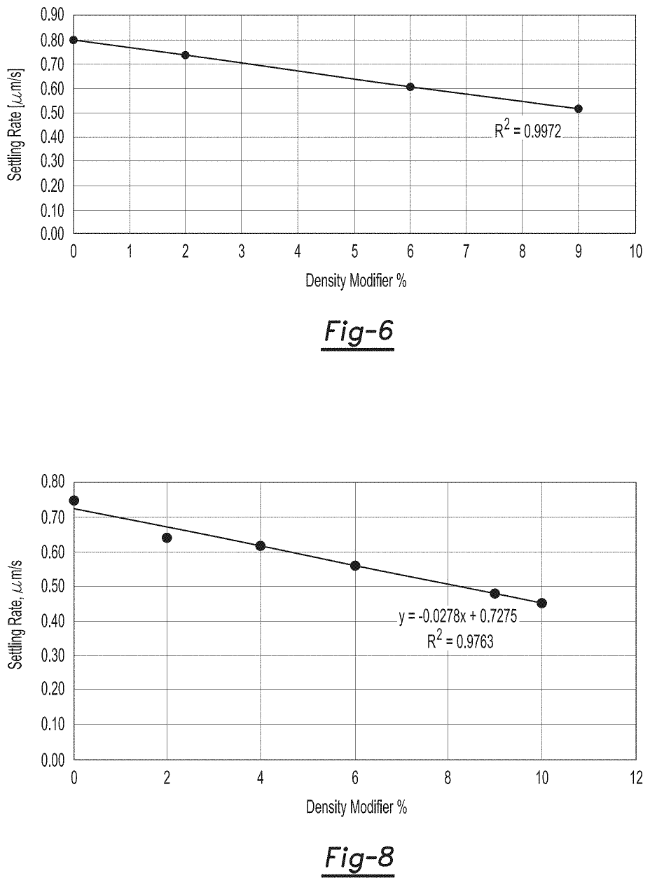

The LUMiSizer™ results for Comp. Ink 4, Ink. C1, Ink C2, and Ink C3 are shown, respectively, in FIG. 5A through FIG. 5D. These graphs depict transmittance (%, Y axis) versus the position (in mm, X axis) of the vial from the front/top at various time points during centrifugation. Curves in red indicate early time points, curves in green indicate later time points, and the colors in between red and green indicate time points in between the early and later time points. The results clearly indicate that the rate at which the low transmittance front moves from the top to bottom of the vial was decreased, indicating that pigment settling and sedimentation was reduced, with an increased amount of the density modifier.

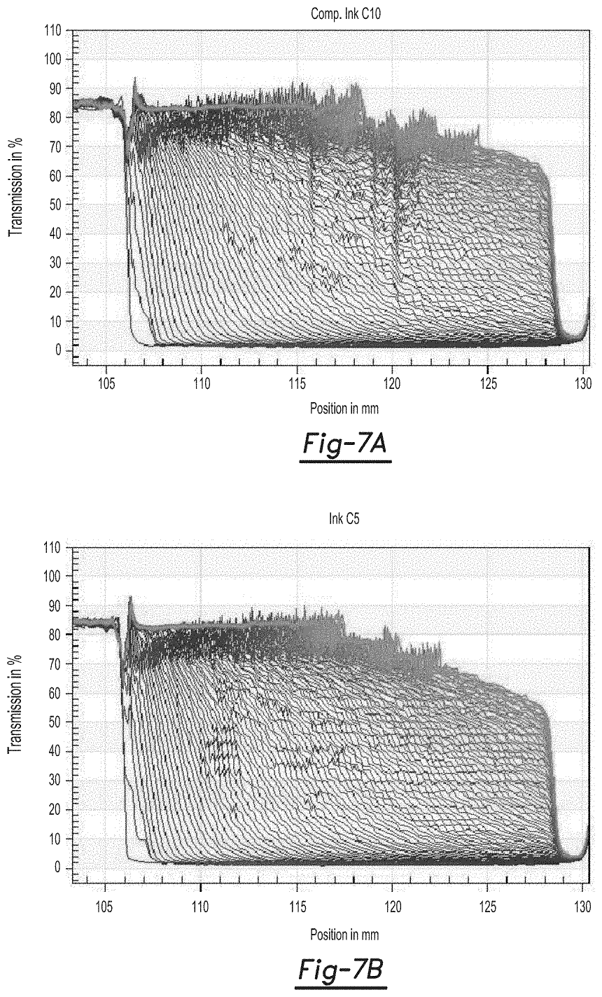

The pigment settling/sedimentation rate was calculated using the Stokes equation (and the calculated ink densities and viscosities). The calculated pigment settling rate (μm/s, Y axis) is plotted against the density modifier content (%, X axis) for each of the example inks and the comparative ink in FIG. 6. The calculated pigment settling rates for the inks (Inks C1, C2, C3, and Comp. Ink C4) were consistent with the LUMiSizer™ results.

### Example 2

Five additional cyan inks were prepared in accordance with the examples disclosed herein. Each of these inks included a different amount of the density modifier, iodixanol (OPTIPREP™ (60%)). An additional comparative example ink was also prepared. The comparative example ink did not include any of the density modifier. The formulations for the five examples inks (Inks C5-C9) and the comparative example ink (Comp. Ink C10) are shown in Table 4.

TABLE 4

| | | | | | | Comp. |
|---|---|---|---|---|---|---|
| | Ink C5 | Ink C6 | Ink C7 | Ink C8 | Ink C9 | Ink C10 |
| | (wt % | (wt % | (wt % | (wt % | (wt % | (wt % |
| Ingredient | active) | active) | active) | active) | active) | active) |
| 1-(2-hydroxyethyl)- | 10 | 10 | 10 | 10 | 10 | 10 |
| 2-pyrrolidone (98%) | | | | | | |
| Glycerol (99%) | 10 | 10 | 10 | 10 | 10 | 10 |
| SURFYNOL ® 104 | 0.3 | 0.3 | 0.3 | 0.3 | 0.3 | 0.3 |
| BRIJ ® O10 | 0.5 | 0.5 | 0.5 | 0.5 | 0.5 | 0.5 |
| ACTICIDE ® B20 | 0.15 | 0.15 | 0.15 | 0.15 | 0.15 | 0.15 |
| (20%) | | | | | | |
| Cyan Dispersion | 3.56 | 3.56 | 3.56 | 3.56 | 3.56 | 3.56 |
| OPTIPREP ™ (60%) | 2 | 4 | 6 | 9 | 10 | 0 |
| Deionized Water | Balance | Balance | Balance | Balance | Balance | Balance |

The viscosity and density of each of the example and comparative example inks were measured. The viscosity was measured at 25° C. and 60 RPM using a Brookfield LVDV-II+ viscometer (with a 00 UL-ULA (0) adapter). The density was measured using a Densito Portable Density Meter, available from Mettler Toledo. These results are shown in Table 5.

TABLE 5

| | Viscosity | Density |
|---|---|---|
| INK ID | (cP) | (g/cm³) |
| Comp. Ink C10 | 3.09 | 1.07 |
| (0% OPTIPREP ™) | | |
| Ink C5 | 3.31 | 1.08 |
| (2% OPTIPREP ™) | | |
| Ink C6 | 3.54 | 1.09 |
| (4% OPTIPREP ™) | | |
| Ink C7 | 3.78 | 1.10 |
| (6% OPTIPREP ™) | | |
| Ink C8 | 4.19 | 1.11 |
| (9% OPTIPREP ™) | | |
| Ink C9 | 4.39 | 1.12 |
| (10% OPTIPREP ™) | | |

As depicted in Table 5, the density modifier increased both the density and the viscosity of the example inks compared Comp. Ink C10. The gap between the pigment density (˜1.6 g/cm³) and the ink density was decreased with an increased amount of the density modifier. Moreover, while the viscosity of the example inks increased compared Comp. Ink C4, the viscosities were still within thermally and piezoelectrically ink jettable viscosities.

The example and comparative example inks were also tested to determine the pigment settling rate. Each of the example ink and the comparative example ink was filled into a vial, and centrifuged using a LUMiSizer™ (LUMiFuge™ 114 from LUM GmbH). In this example, the LUMiSizer™ was operated at the following conditions: acceleration due to gravity (m/s²) was 9.8 and RCA @ 4000 RPM, in g was 2000 (2000 times compared to gravity). Centrifugation occurred at 100 second intervals for a 13 hour period. The transmittance of the samples through the vials was measured throughout centrifugation.

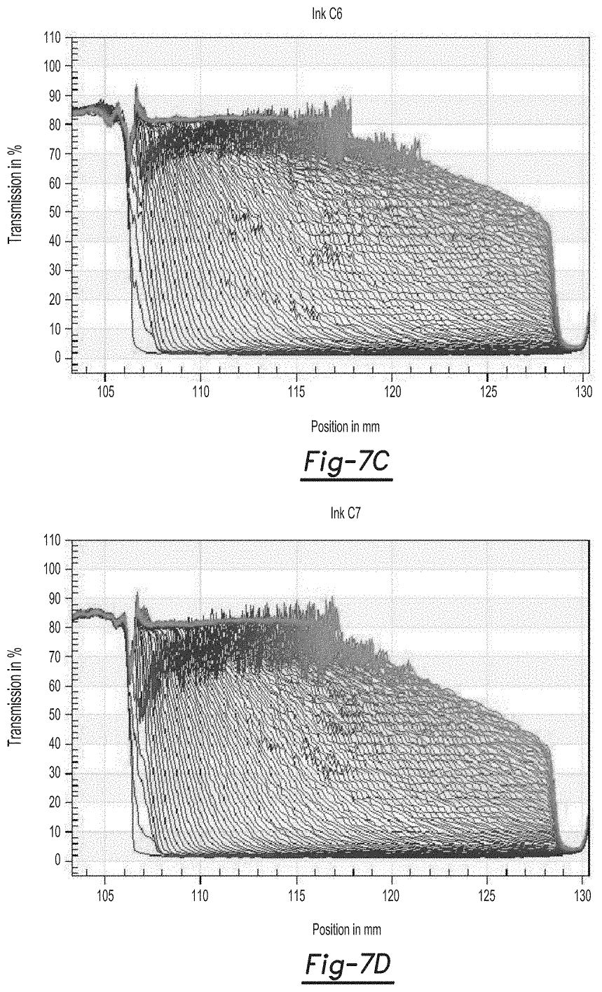

The LUMiSizer™ results for Comp. Ink 10, Ink. C5, Ink C6, Ink C7, Ink C8, and Ink C9 are shown, respectively, in FIG. 7A through FIG. 7F. These graphs depict transmittance (%, Y axis) versus the position (in mm, X axis) of the vial from the front/top at various time points during centrifugation. Curves in red indicate early time points and those in green later time points as described in Example 1. The results clearly indicate that transmittance was increased, indicating that pigment settling and sedimentation was reduced, with an increased amount of the density modifier.

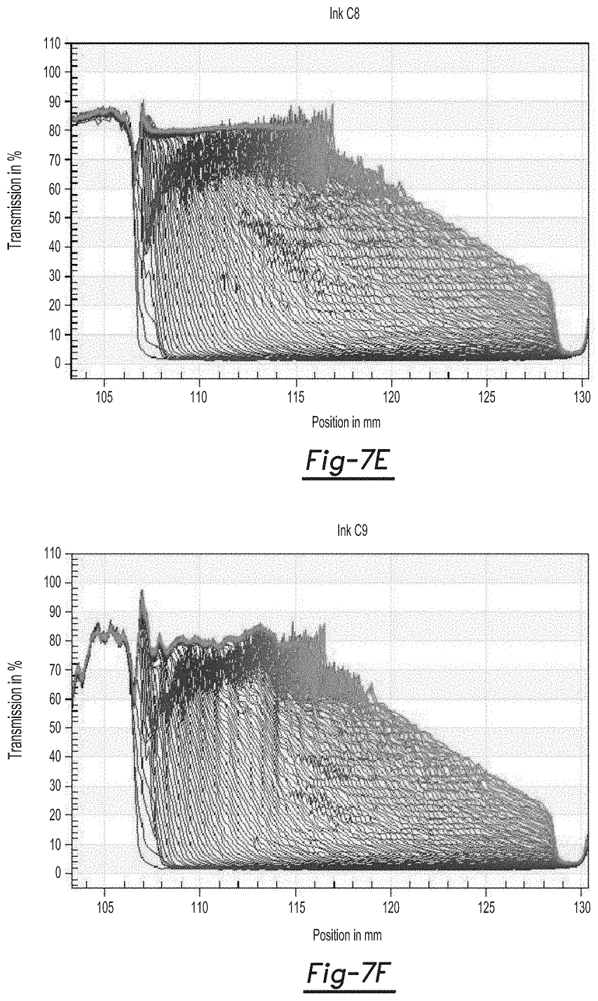

The pigment settling/sedimentation rate was calculated using the Stokes equation (and the calculated ink densities and viscosities). The calculated pigment settling rate (μm/s, Y axis) is plotted against the density modifier content (%, X axis) for each of the example inks and the comparative ink in FIG. 8. The calculated pigment settling rates for the inks (Inks C5-C9, and Comp. Ink C10) were consistent with the LUMiSizer™ results. The results in Example 2 were also consistent with the results in Example 1.

Unless otherwise stated, any feature described hereinabove can be combined with any example or any other feature described herein. In addition, it is to be understood that the described elements for any example may be combined in any suitable manner in the various examples unless the context clearly dictates otherwise.

In describing and claiming the examples disclosed herein, the singular forms “a,” “an,” and “the” include plural referents unless the context clearly dictates otherwise.

It is to be understood that concentrations, amounts, and other numerical data may be expressed or presented herein in range formats. It is to be understood that the ranges provided herein include the stated range and any value or sub-range within the stated range, as if the value(s) or sub-range(s) within the stated range were explicitly recited. For example, a range from about 2 wt % active to about 10 wt % active, should be interpreted to include not only the explicitly recited limits of from about 2 wt % active to about 10 wt % active, but also to include individual values, such as about 4.15 wt % active, about 5.5 wt % active, 6.0 wt % active, 6.77 wt % active, 8 wt % active, 9.33 wt % active, etc., and sub-ranges, such as from about 5 wt % active to about 10 wt % active, from about 3 wt % active to about 7.5 wt % active, from about 2.5 wt % active to about 8.5 wt % active, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

While several examples have been described in detail, it is to be understood that the disclosed examples may be modified. Therefore, the foregoing description is to be considered non-limiting.

What is claimed is:

1. An inkjet composition, comprising:
a colorant;
a density modifier selected from the group consisting of a triiodo amino derivative of isophthalic acid, a mixture of polysucrose and sodium diatrizoate, colloidal silica particles coated with polyvinylpyrrolidone, and combinations thereof; and
an aqueous vehicle.

2. The inkjet composition as defined in claim 1, wherein the density modifier is the triiodo amino derivative of isophthalic acid.

3. The inkjet composition as defined in claim 2, wherein the triiodo amino derivative of isophthalic acid is selected from the group consisting of diatrizoate, iodixanol, iohexol, deacetyliodixanol, iopam idol, ioxilan, ioversol, iomeprol, iobitridol, iopentol, ioforminol, iopiperidol, iosimenol, and combinations thereof.

4. The inkjet composition as defined in claim 1, wherein the density modifier is present in an amount ranging from about 2 wt % active to about 10 wt % active based on a total weight of the inkjet composition.

5. The inkjet composition as defined in claim 1, wherein the colorant is a pigment.

6. The inkjet composition as defined in claim 5, wherein:
a density of the pigment ranges from about 1.4 g/cm³ to about 1.6 g/cm³; and
a density of the inkjet composition ranges from about 1.0 g/cm³ to about 1.2 g/cm³.

7. The inkjet composition as defined in claim 1, wherein the aqueous vehicle comprises water, a co-solvent, and an additive selected from the group consisting of a surfactant, an anti-kogation agent, an anti-decel agent, an antimicrobial agent, and combinations thereof.

8. The inkjet composition as defined in claim 1, wherein:
the density modifier is the triiodo amino derivative of isophthalic acid;
the triiodo amino derivative of isophthalic acid iodixanol; and
the density modifier is present in an amount ranging from about 2 wt % active to about 9 wt % active based on a total weight of the inkjet composition.

9. The inkjet composition as defined in claim 1, wherein:
the colorant is a dye; and
the aqueous vehicle includes at least one carbohydrate-containing solvent present in an amount ranging from about 15 wt % active to about 50 wt % active based on a total weight of the inkjet composition.

10. The inkjet composition as defined in claim 9, wherein the at least one carbohydrate-containing solvent includes a carbohydrate selected from the group consisting of sorbitol, glucose, fructose, sucrose, sucralose, and mixtures thereof.

11. The inkjet composition as defined in claim 9, wherein:
a density of the dye ranges from about 1.1 g/cm³ to about 1.4 g/cm³; and
a density of the inkjet composition ranges from about 1.0 g/cm³ to about 1.2 g/cm³.

12. The inkjet composition as defined in claim 9, wherein the density modifier is the triiodo amino derivative of isophthalic acid, and the triiodo amino derivative of isophthalic acid is iodixanol.

13. A printing method, comprising:
inkjet printing an inkjet ink composition onto at least a portion of a substrate, the inkjet ink composition including:
a pigment;
a density modifier selected from the group consisting of a triiodo amino derivative of isophthalic acid, a mixture of polysucrose and sodium diatrizoate, colloidal silica particles coated with polyvinylpyrrolidone, and combinations thereof; and
an aqueous ink vehicle.

14. The printing method as defined in claim 13, wherein:
the inkjet ink composition is inkjet printed from an inkjet printer; and
prior to inkjet printing the inkjet ink composition, the method further comprises:
printing a shipping fluid composition from a pen of the inkjet printer, the shipping fluid composition comprising:
at least one carbohydrate-containing solvent present in an amount ranging from about 15 wt % active to about 50 wt % active based on a total weight of the shipping fluid composition;
a density modifier selected from the group consisting of a triiodo amino derivative of isophthalic acid, a mixture of polysucrose and sodium diatrizoate, colloidal silica particles coated with polyvinylpyrrolidone, and combinations thereof; and
an aqueous shipping fluid vehicle; and
introducing an inkjet supply containing the inkjet ink composition in fluid communication with the pen of the inkjet printer.

15. A method for decreasing sedimentation in an inkjet composition, comprising:
incorporating a colorant having a first density into an aqueous vehicle having a second density that is lower than the first density; and
adding a density modifier to the aqueous vehicle that reduces a difference between the first density and the second density, the density modifier being selected from the group consisting of a triiodo amino derivative of isophthalic acid, a mixture of polysucrose and sodium diatrizoate, colloidal silica particles coated with polyvinylpyrrolidone, and combinations thereof.
